(19) United States
(12) Patent Application Publication
(10) Pub. No.: US 2015/0042601 A1
(43) Pub. Date: Feb. 12, 2015

(54) TOUCH SCREEN PANEL AND DISPLAY DEVICE INCLUDING THE SAME

(71) Applicant: Samsung Display Co., Ltd., Yongin-si (KR)

(72) Inventors: Il Ho LEE, Pyeongtaek-si (KR); In Cheol KIM, Goyang-si (KR); Seung Ho NAM, Seongnam-si (KR); Yoon Gyu LEE, Uijeongbu-si (KR); Hyun-Ju LEE, Seoul (KR)

(73) Assignee: Samsung Display Co., Ltd., Yongin-si (KR)

(21) Appl. No.: 14/143,363

(22) Filed: Dec. 30, 2013

(30) Foreign Application Priority Data
Aug. 12, 2013 (KR) 10-2013-0095580

(51) Int. Cl. G06F 3/044

(52) U.S. Cl. CPC G06F 3/044
USPC 345/174

(57) ABSTRACT

A touch screen panel includes a lower substrate, a plurality of sensing wires disposed on the lower substrate in a first direction, an insulating layer disposed on the plurality of sensing wires, and a plurality of sensing pads disposed on the insulating layer, where a plurality of contact holes is defined in the insulating layer, and the plurality of sensing pads is connected to the plurality of sensing wires through the plurality of contact holes, respectively.

This application claims priority to Korean Patent Application No. 10-2013-0095580 filed on Aug. 12, 2013, and all the benefits accruing therefrom under 35 U.S.C. §119, the entire contents of which are incorporated herein by reference.

### BACKGROUND

(a) Field

Exemplary embodiments of the invention relates to a touch screen panel and a display device including the same, and more particularly, to a touch screen panel without a dead zone and a display device including the same.

(b) Description of the Related Art

A touch screen panel is an input device inputting a user's command by recognizing a touch position of the user. The touch screen panel is provided on a front side of a display device to catch a position which is touched by a hand or an object to determine an input signal. A type of implementing the touch screen panel includes a resistive type, a capacitive type, an infrared type, an ultrasonic type, and the like. In general, the resistive type and the capacitive type are mainly used.

Particularly, in a structure of providing a minute electrode pattern and slimming a thickness, the capacitive type has been preferred. A capacitive type touch screen panel senses that capacitance between electrodes is changed when a finger touches the touch screen panel to detect a touch position.

In the capacitive type, a self cap type, in which each of a plurality of touch pads included in the touch screen panel is directly connected to a touch sensing unit and senses that capacitance provided in the plurality of touch pads itself is changed, is included. In the self cap type, since a sensing wire is connected to each of the plurality of touch pads, the sensing wires need to be provided by the number of touch pads.

### SUMMARY

In the self cap type, the sensing wires are positioned at the left and right of the touch pad, and a portion with the sensing wire becomes a dead zone in which a touch is not sensed. Particularly, as the touch screen panel is large-sized, the number of touch pads and the number of sensing wires are increased, and the dead zone is increased by the increased number.

Such a dead zone causes deterioration of touch sensitivity of the touch screen panel.

Exemplary embodiments of the invention have been made in an effort to provide a touch screen panel and a display device including the same having advantages of removing a dead zone in a self cap type touch screen panel.

An exemplary embodiment of the invention provides a touch screen panel, including a lower substrate, a plurality of sensing wires disposed on the lower substrate in a first direction, an insulating layer disposed on the plurality of sensing wires, and a plurality of sensing pads disposed on the insulating layer, in which a plurality of contact holes is defined in the insulating layer, and the plurality of sensing pads is connected to the plurality of sensing wires through the plurality of contact holes, respectively.

In an exemplary embodiment, a number of the plurality of sensing wires may be same as that of the plurality of sensing pads.

In an exemplary embodiment, the touch screen panel may further include a touch sensing unit connected to the plurality of sensing wires and sensing a change of a capacitance generated in the plurality of sensing pads to detect a touch position.

In an exemplary embodiment, the plurality of sensing pads may include n sensing pads arranged in the first direction, and n sensing wires may be disposed below the n sensing pads.

In an exemplary embodiment, the plurality of sensing wires may include an electro-conductive metal material.

In an exemplary embodiment, the plurality of sensing pads may include an electro-conductive transparent material.

Another exemplary embodiment of the invention provides a display device, including a thin film transistor (“TFT”) array panel, a common electrode panel facing the TFT array panel, a liquid crystal layer interposed between the TFT array panel and the common electrode panel, a plurality of sensing wires disposed on the common electrode panel in a first direction, an insulating layer disposed on the plurality of sensing wires, and a plurality of sensing pads disposed on the insulating layer, in which a plurality of contact holes is defined in the insulating layer, and the plurality of sensing pads is connected to the plurality of sensing wires through the plurality of contact holes, respectively.

In an exemplary embodiment, the display device may further include a light blocking member disposed below the common electrode panel to cover a region with a TFT in the TFT array panel, in which the plurality of sensing wires may be disposed on the light blocking member.

In an exemplary embodiment, a number of the plurality of sensing wires may be same as that of the plurality of sensing pads.

In an exemplary embodiment, the display device may further include a touch sensing unit connected to the plurality of sensing wires and sensing a change of a capacitance generated in the plurality of sensing pads to detect a touch position.

Yet another exemplary embodiment of the invention provides a display device, including a TFT array panel, a common electrode panel facing the TFT array panel, and a touch screen panel layer disposed between the TFT array panel and the common electrode panel, in which the touch screen panel layer includes a plurality of sensing wires disposed in a first direction, an insulating layer disposed below the plurality of sensing wires, and a plurality of sensing pads disposed below the insulating layer, and a plurality of contact holes is defined in the insulating layer, and the plurality of sensing pads is connected to the plurality of sensing wires through the plurality of contact holes, respectively.

In an exemplary embodiment, the display device may further include a light blocking member disposed below the common electrode panel to cover a region with a TFT in the TFT array panel, in which the plurality of sensing wires may be disposed below the light blocking member.

In an exemplary embodiment, the display device may further include a color filter disposed in a pixel area between a plurality of light blocking members below the common electrode panel.

In an exemplary embodiment, the display device may further include a color filter disposed in a pixel area which overlaps an opening defined between a plurality of light blocking member on the TFT array panel.

In an exemplary embodiment, the display device may further include a light blocking member disposed on the TFT array panel to cover a region with a TFT in the TFT array panel, in which the plurality of sensing wires may be disposed below the common electrode panel on a portion where the light blocking member is positioned.

In an exemplary embodiment, the display device may further include a color filter disposed in a pixel area which overlaps an opening defined between a plurality of light blocking member on the TFT array panel.

In an exemplary embodiment, the display device may further include a first polarizer disposed below the TFT array panel, and a second polarizer disposed on the common electrode panel.

Still another exemplary embodiment of the invention provides a display device, including a liquid crystal panel assembly including a TFT array panel, a common electrode panel facing the TFT array panel, and a liquid crystal layer interposed between the TFT array panel and the common electrode panel, and a touch screen panel including tempered glass, a plurality of sensing wires disposed on the tempered glass in a first direction, an insulating layer disposed on the plurality of sensing wires, and a plurality of sensing pads disposed on the insulating layer to be connected to the plurality of sensing wires through a plurality of contact holes defined in the insulation layer, in which an adhesive member is provided on the liquid crystal panel assembly, and the plurality of sensing pads of the touch screen panel adheres to the adhesive member.

In an exemplary embodiment, a number of the plurality of sensing wires may be same as that of the plurality of sensing pads.

In an exemplary embodiment, the display device may further include a touch sensing unit connected to the plurality of sensing wires and sensing a change in capacitance generated by the plurality of sensing pads to detect a touch position.

According to the exemplary embodiments of the invention, it is possible to remove a dead zone in a self cap type touch screen panel and improve touch sensitivity of the touch screen panel.

### BRIEF DESCRIPTION OF THE DRAWINGS

The above and other exemplary embodiments, advantages and features of this disclosure will become more apparent by describing in further detail exemplary embodiments thereof with reference to the accompanying drawings, in which:

FIG. 1 is a plan view illustrating an exemplary embodiment of a touch screen panel according to the invention.

FIG. 2 is a cross-sectional view illustrating the exemplary embodiment of a cross section taken along line II-II in the touch screen panel according to the invention.

FIG. 3 is a cross-sectional view illustrating an exemplary embodiment of a display device including a touch screen panel according to the invention.

FIG. 4 is a cross-sectional view illustrating another exemplary embodiment of a display device including a touch screen panel according to the invention.

FIG. 5 is a cross-sectional view illustrating an exemplary embodiment of a display device including a touch screen panel according to the invention.

FIG. 6 is a cross-sectional view illustrating another exemplary embodiment of a display device including a touch screen panel according to the invention.

FIG. 7 is a plan view illustrating a display device including another exemplary embodiment of a touch screen panel according to the invention.

FIG. 8 is a cross-sectional view illustrating a cross section taken along line VIII-VIII in the display device of FIG. 7.

### DETAILED DESCRIPTION

The invention will be described more fully hereinafter with reference to the accompanying drawings, in which exemplary embodiments of the invention are shown. As those skilled in the art would realize, the described exemplary embodiments may be modified in various different ways, all without departing from the spirit or scope of the invention.

Further, in exemplary embodiments, since like reference numerals designate like elements having the same configuration, a first exemplary embodiment is representatively described, and in other exemplary embodiments, only a configuration different from the first exemplary embodiment will be described.

The drawings and description are to be regarded as illustrative in nature and not restrictive, and like reference numerals designate like elements throughout the specification.

In the drawings, the thickness of layers, films, panels, regions, etc., are exaggerated for clarity. It will be understood that when an element such as a layer, film, region, or substrate is referred to as being “on” another element, it can be “directly on” the other element or intervening elements may also be present. In contrast, when an element is referred to as being “directly on” another element, there are no intervening elements present. Similarly, it will be understood that when an element such as a layer, film, region, or substrate is referred to as being “under” another element, it can be “directly under” the other element or intervening elements may also be present.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10%, 5% of the stated value.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

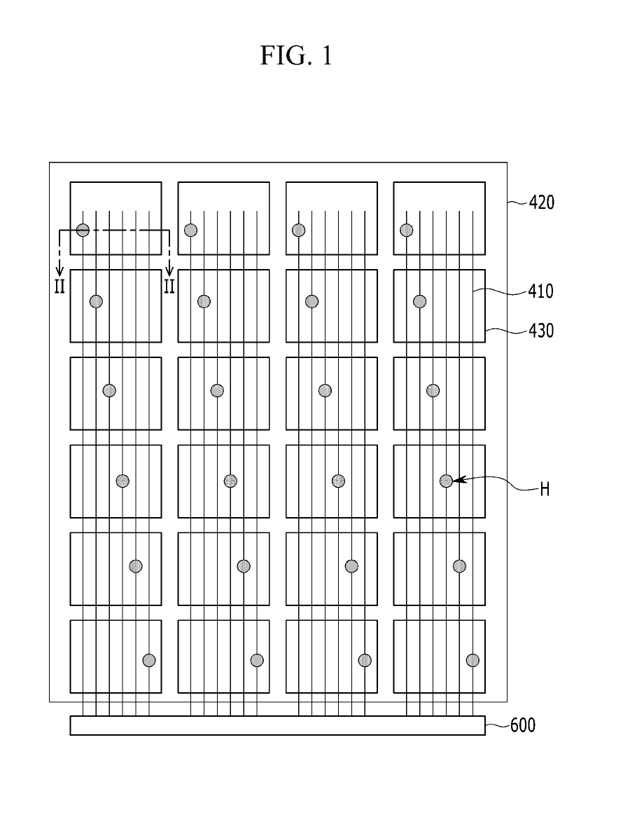

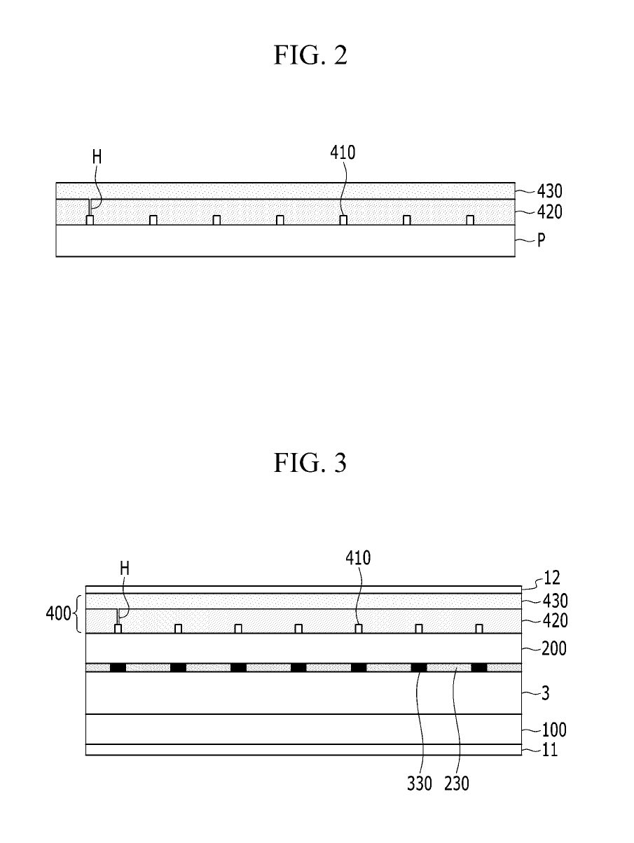

FIG. 1 is a plan view illustrating a touch screen panel according to an exemplary embodiment of the invention. FIG. 2 is a cross-sectional view illustrating a cross section taken along line II-II in the touch screen panel according to the exemplary embodiment of the invention.

Referring to FIGS. 1 and 2, a touch screen panel includes a plurality of sensing pads 430, a plurality of sensing wires 410 electrically connected to the plurality of sensing pads 430, and an insulating layer 420 between the plurality of sensing pads 430 and the plurality of sensing wires 410. A touch sensing unit 600 detecting a touch position is connected to the plurality of sensing wires 410.

In an exemplary embodiment, the plurality of sensing pads 430 may be arranged in a matrix form. That is, the plurality of sensing pads 430 may be arranged in a first direction and a second direction which is vertical to the first direction. In an exemplary embodiment, the plurality of sensing pads 430 may be provided in a quadrangular shape. Here, the invention is not limited thereto, and the plurality of sensing pads 430 may be provided in various other shapes as a triangle, a hexagon, a specific polygon, and the like. The plurality of pixel electrode 430 may include an electro-conductive transparent metal material such as indium tin oxide (“ITO”) and indium zinc oxide (“IZO”).

The plurality of sensing wires 410 is disposed on a lower substrate P in the first direction. One end of the plurality of sensing wires 410 is connected to the touch sensing unit 600. The plurality of sensing wires 410 may be disposed below the plurality of sensing pads 430 in the first direction at a predetermined distance between the plurality of sensing wires 410. In an exemplary embodiment, a number of the plurality of sensing wires 410 may be same as that of the plurality of sensing pads 430. That is, when n sensing pads 430 are arranged in the first direction, n sensing wires 410 are disposed below the n sensing pads 430. When m sensing pad groups in which the n sensing pads 430 are arranged in the first direction are arranged in the second direction, n×m sensing wires 410 are disposed. One end of the n×m sensing wires 410 is connected to the touch sensing unit 600.

In an exemplary embodiment, the lower substrate P may include a transparent material such as glass and plastic. In an exemplary embodiment, the lower substrate P may include a substrate separately provided for the touch screen panel. Further, in another exemplary embodiment, the lower substrate P is not provided for the touch screen panel, but may be provided for a common electrode panel or tempered glass of the display device to be described below, or the like.

The plurality of sensing wires 410 may include a metal material having excellent electric conductivity. In an exemplary embodiment, the metal material having excellent electric conductivity includes silver (Ag), gold (Au), platinum (Pt), copper (Cu), molybdenum (Mo), aluminum (Al), and the like. The metal material used as the plurality of sensing wires 410 is subjected to low reflection so as not to reflect light incident from an upper side. A width of the plurality of sensing wires 410 perpendicular to an elongation of the plurality of sensing wires 410, respectively, is approximately 10 micrometers (μm) to approximately 20 μm, and a distance between the plurality of sensing wires 410 is about hundreds μm. Accordingly, the plurality of sensing wires 410 which is subjected to low reflection is not recognized by a user and has little effect on a luminance rate of the display device.

In an exemplary embodiment, the plurality of sensing wires 410 may include an electro-conductive transparent material such as ITO and IZO.

The insulating layer 420 is disposed on the entire lower substrate P with the plurality of sensing wires 410. The insulating layer 420 may include an inorganic insulating material such as silicon nitride (SiNx) and silicon oxide (SiOx). Alternately, the insulating layer 420 may include an organic insulating material. The insulating layer 420 surrounds the plurality of sensing wires 410 and electrically insulates the plurality of sensing wires 410 from the outside.

A plurality of contact holes H corresponding to the plurality of sensing pads 430 is disposed in the insulating layer 420. In an exemplary embodiment, the plurality of contact holes H may be defined by a photolithography process. The plurality of contact holes H is defined at a position corresponding to the position of the plurality of sensing wires 410, and the plurality of sensing wires 410 are exposed by the contact holes H. One contact hole H is defined for each of the plurality of sensing wires 410, and one sensing pad 430 is disposed to correspond to one contact hole H.

The plurality of sensing pads 430 is disposed on the insulating layer 420 with the plurality of contact holes H. In an exemplary embodiment, the plurality of sensing pads 430 may be provided by depositing a metal material on the insulating layer 420 by a deposition method such as physical vapor deposition (“PVD”) and chemical vapor deposition (“CVD”). In the deposition process of the metal material, the metal material is filled in the plurality of contact holes H, and each of the plurality of sensing pads 430 is connected to any one sensing wire 410 through the contact hole H.

An electrode to which a predetermined voltage such as a common voltage is applied may be disposed below the lower substrate P, and the plurality of sensing pads 430 may provide a first predetermined capacitance with the electrode of the lower substrate P. When a finger touches at least one of the plurality of sensing pads 430, a second capacitance is generated between the finger and the sensing pad 430, and the first capacitance is changed by the second capacitance. A value of the changed first capacitance is transferred to the touch sensing unit 600 through the sensing wire 410 connected to the sensing pad 430 which is touched by the finger. The touch sensing unit 600 may check the sensing wire 410 receiving the value of the first capacitance to detect a touch position. That is, the touch sensing unit 600 senses a change in capacitance generated by the plurality of sensing pads 430 to detect the touch position.

Hereinafter, a configuration of the display device including the touch screen panel described above will be described with reference to FIGS. 3 to 6. For convenience of description, a cross section taken along line II-II of FIG. 1 in the display device including the touch screen panel will be described as an exemplary embodiment. When a configuration of the display device including the touch screen panel is described, constituent elements which do not limit a structural characteristic that the touch screen panel is included in the display device are omitted. However, the provided display device is not limited thereto.

FIG. 3 is a cross-sectional view illustrating a display device including a touch screen panel according to an exemplary embodiment of the invention.

Referring to FIG. 3, the display device includes a thin film transistor (“TFT”) array panel 100, a common electrode panel 200 facing the TFT array panel 100, a liquid crystal layer 3 interposed between the two panels 100 and 200, and a touch screen panel layer 400 disposed on the common electrode panel 200.

The TFT array panel 100 includes a TFT and a pixel electrode connected thereto. The common electrode panel 200 includes a common electrode facing the pixel electrode.

Hereinafter, since configurations of the TFT array panel 100 and the common electrode panel 200 are known, description of the configurations will be omitted.

A color filter 230 and a light blocking member 330 are disposed between the TFT array panel 100 and the common electrode panel 200, that is, below the common electrode panel 200. The light blocking member 330 is disposed to fully cover a region with the TFT, and the color filter 230 is disposed in a pixel area between the light blocking members 330. The light blocking member 330 may be positioned to be at least partially overlapped with data lines positioned at both sides of one pixel area, and effectively prevents light leakage which may occur near the data line and the gate line. In an exemplary embodiment, the color filter 230 may display any one of three primary colors of red, green, and blue.

By an electric field disposed between the pixel electrode of the TFT array panel 100 and the common electrode of the common electrode panel 200, alignment of liquid crystal molecules included in the liquid crystal layer 3 is changed and a light amount passing through the liquid crystal layer 3 is controlled, and as a result, grays are expressed.

The touch screen panel layer 400 is disposed on the common electrode panel 200. The touch screen panel layer 400 includes a plurality of sensing wires 410, an insulating layer 420, and a plurality of sensing pads 430.

The plurality of sensing wires 410 is disposed directly on the common electrode panel 200. The plurality of sensing wires 410 may be disposed at a portion where the light blocking member 330 is positioned. That is, the plurality of sensing wires 410 may be disposed on the light blocking member 330. The plurality of sensing wires 410 is disposed on the light blocking member 330 to effectively prevent light emitted from a backlight device (not illustrated) positioned below the TFT array panel 100 from being reflected and interfering by the plurality of sensing wires 410.

The insulating layer 420 is disposed on the plurality of sensing wires 410, and the plurality of sensing pads 430 is disposed on the insulating layer 420. In this case, the insulating layer 420 may be disposed on the plurality of sensing wires 410 and the light blocking member 330. The insulating layer 420 may surround the plurality of sensing wires 410. Each of the plurality of sensing pads 430 is connected to one sensing wire 410 through the contact hole H.

A pair of polarizers 11 and 12 is attached to outer sides of the TFT array panel 100 and the plurality of sensing pads 430. A first polarizer 11 is disposed below the TFT array panel 100, and a second polarizer 12 is disposed on the plurality of sensing pads 430. That is, the second polarizer 12 is disposed on the touch screen panel layer 400.

The plurality of sensing pads 430 provides a first predetermined capacitance with the common electrode included in the common electrode panel 200, and when the finger touches at least one of the plurality of sensing pads 430, a second capacitance is generated between the finger and the sensing pad 430, and the first capacitance is changed by the second capacitance. A changed value in the first capacitance is transferred to the touch sensing unit 600 through the sensing wire 410 connected to the sensing pad 430 which is touched by the finger, and the touch sensing unit 600 checks the sensing wire 410 receiving the changed value in the first capacitance to detect a touch position.

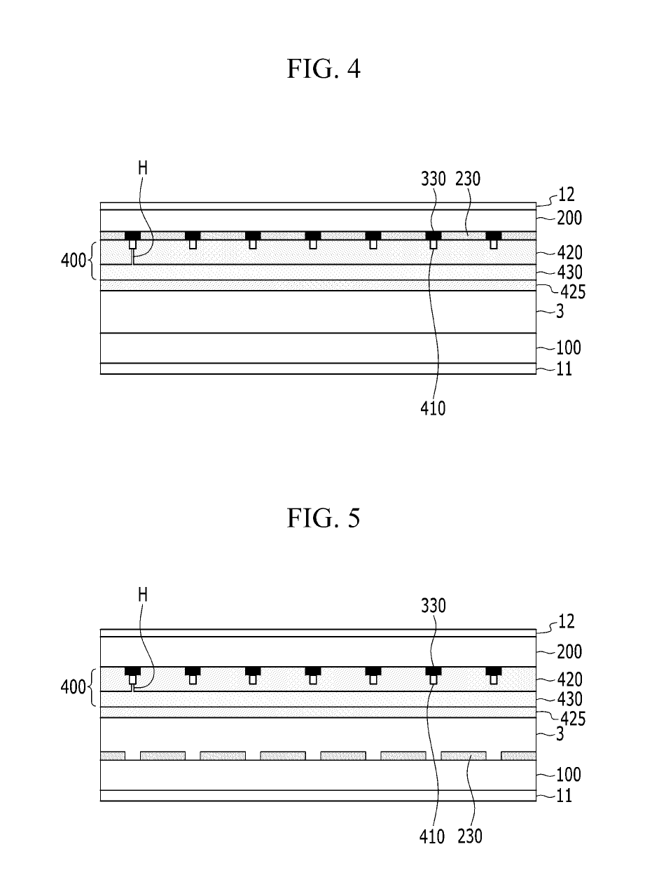

FIG. 4 is a cross-sectional view illustrating a display device including a touch screen panel according to another exemplary embodiment of the invention.

Referring to FIG. 4, the display device includes a TFT array panel 100, a common electrode panel 200 facing the TFT array panel 100, a touch screen panel layer 400 disposed below the common electrode panel 200, and a liquid crystal layer 3 interposed between the TFT array panel 100 and the common electrode panel 200.

A color filter 230 and a light blocking member 330 are disposed between the TFT array panel 100 and the common electrode panel 200, that is, under the common electrode panel 200. The light blocking member 330 is provided to fully cover a region with the TFT, and the color filter 230 is disposed in a pixel area between the light blocking members 330. The light blocking member 330 may be positioned to be at least partially overlapped with data lines positioned at both sides of one pixel area, and effectively prevents light leakage which may occur near the data line and the gate line. In an exemplary embodiment, the color filter 230 may display any one of three primary colors of red, green, and blue.

The touch screen panel layer 400 is disposed below the common electrode panel 200, the light blocking member 330 and the color filter 230. That is, the touch screen panel layer 400 is disposed below the light blocking member 330 and the color filter 230.

The touch screen panel layer 400 includes a plurality of sensing wires 410, a first insulating layer 420 and a plurality of sensing pads 430.

The plurality of sensing wires 410 is disposed below the light blocking member 330. That is, the plurality of sensing wires 410 may be disposed directly below the light blocking member 330. The plurality of sensing wires 410 is disposed below the light blocking member 330, and as a result, the plurality of sensing wires 410 may not reflect the light incident from the upper side. The plurality of sensing wires 410 is subjected to low reflection to effectively prevent light emitted from a backlight device (not illustrated) positioned below the TFT array panel 100 from being reflected and interfering by the plurality of sensing wires 410.

The first insulating layer 420 is disposed below the plurality of sensing wires 410, and the plurality of sensing pads 430 is disposed below the first insulating layer 420. The first insulating layer 420 may be disposed to surround a plurality of sensing wires 410. Each of the plurality of sensing pads 430 is connected to one sensing wire 410 through the contact hole H.

A second insulating layer 425 is disposed below the plurality of sensing pads 430. The liquid crystal layer 3 is interposed between the second insulating layer 425 and TFT array panel 100.

A pair of polarizers 11 and 12 is attached to outer sides of the TFT array panel 100 and the common electrode panel 200. A first polarizer 11 is disposed below the TFT array panel 100, and a second polarizer 12 is disposed on the common electrode panel 200.

FIG. 5 is a cross-sectional view illustrating a display device including a touch screen panel according to an exemplary embodiment of the invention.

Referring to FIG. 5, the display device includes a TFT array panel 100, a common electrode panel 200 facing the TFT array panel 100, a touch screen panel layer 400 disposed below the common electrode panel 200, and a liquid crystal layer 3 interposed between the TFT array panel 100 and the common electrode panel 200.

A light blocking member 330 is disposed below the common electrode panel 200. The light blocking member 330 is disposed to fully cover a region with the TFT. The light blocking member 330 may be positioned to be at least partially overlapped with data lines positioned at both sides of one pixel area, and effectively prevents light leakage which may occur near the data line and the gate line.

A color filter 230 is disposed on the TFT array panel 100. The color filter 230 is disposed in a pixel area overlapping an opening defined between light blocking members 330. In an exemplary embodiment, the color filter 230 may display any one of three primary colors of red, green, and blue.

The touch screen panel layer 400 is disposed below the common electrode panel 200. The touch screen panel layer 400 includes a plurality of sensing wires 410, a first insulating layer 420, and a plurality of sensing pads 430.

The plurality of sensing wires 410 is disposed below the light blocking member 330. That is, the plurality of sensing wires 410 may be disposed directly below the light blocking member 330. The plurality of sensing wires 410 is disposed below the light blocking member 330, and as a result, the plurality of sensing wires 410 may not reflect the light incident from the upper side. The plurality of sensing wires 410 is processed by low reflection to effectively prevent light emitted from a backlight device (not illustrated) positioned below the TFT array panel 100 from being reflected and interfering by the plurality of sensing wires 410.

The first insulating layer 420 is disposed below the plurality of sensing wires 410. In this case, the first insulating layer 420 may be provided to surround the plurality of sensing wires 410 and the light blocking member 330. The plurality of sensing pads 430 is disposed below the first insulating layer 420. Each of the plurality of sensing pads 430 is connected to one sensing wire 410 through the contact hole H.

A second insulating layer 425 is disposed below the plurality of sensing pads 430. The liquid crystal layer 3 is interposed between the second insulating layer 425 and TFT array panel 100.

A pair of polarizers 11 and 12 is attached to outer sides of the TFT array panel 100 and the common electrode panel 200. A first polarizer 11 is attached below the TFT array panel 100, and a second polarizer 12 is attached onto the common electrode panel 200.

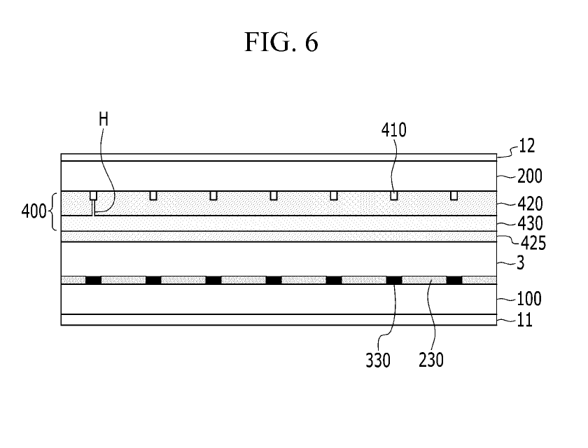

FIG. 6 is a cross-sectional view illustrating a display device including a touch screen panel according to another exemplary embodiment of the invention.

Referring to FIG. 6, the display device includes a TFT array panel 100, a common electrode panel 200 facing the TFT array panel 100, a touch screen panel layer 400 disposed below the common electrode panel 200, and a liquid crystal layer 3 interposed between the touch screen panel layer 400 and the TFT array panel 100.

A color filter 230 and a light blocking member 330 are disposed on the TFT array panel 100. The light blocking member 330 is provided to fully cover a region with the TFT, and the color filter 230 is disposed in a pixel area between the light blocking members 330. The light blocking member 330 may be positioned to be at least partially overlapped with data lines positioned at both sides of one pixel area, and effectively prevents light leakage which may occur near the data line and the gate line. In an exemplary embodiment, the color filter 230 may display any one of three primary colors of red, green, and blue.

The touch screen panel layer 400 is disposed below the common electrode panel 200. The touch screen panel layer 400 includes a plurality of sensing wires 410, a first insulating layer 420, and a plurality of sensing pads 430.

The plurality of sensing wires 410 is disposed below the common electrode panel 200. The plurality of sensing wires 410 may be disposed on a portion where the light blocking member 330 is positioned. That is, the plurality of sensing wires 410 may be disposed on the light blocking member 330. The plurality of sensing wires 410 is disposed on the light blocking member 330 to effectively prevent light emitted from a backlight device (not illustrated) positioned below the TFT array panel 100 from being reflected and interfering by the plurality of sensing wires 410.

The first insulating layer 420 is disposed below the plurality of sensing wires 410. In this case, the first insulating layer 420 may be provided to surround the plurality of sensing wires 410 and the light blocking member 330. The plurality of sensing pads 430 is disposed below the first insulating layer 420. Each of the plurality of sensing pads 430 is connected to one sensing wire 410 through the contact hole H.

A second insulating layer 425 is disposed below the plurality of sensing pads 430. The liquid crystal layer 3 is interposed between the second insulating layer 425 and TFT array panel 100. The liquid crystal layer 3 may be interposed between a layer with the color filter 230 and the light blocking member 330 and the second insulating layer 425.

A pair of polarizers 11 and 12 is attached to outer sides of the TFT array panel 100 and the common electrode panel 200. A first polarizer 11 is disposed below the TFT array panel 100, and a second polarizer 12 is disposed onto the common electrode panel 200.

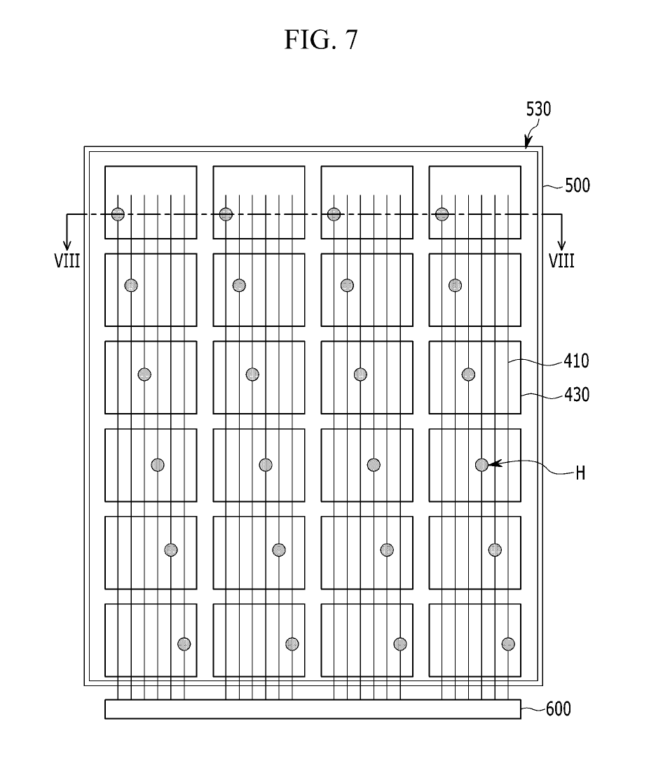

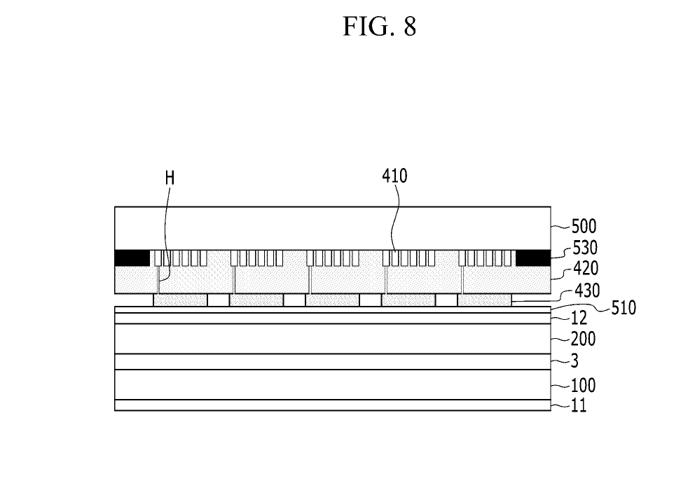

FIG. 7 is a plan view illustrating a display device including a touch screen panel according to another exemplary embodiment of the invention. FIG. 8 is a cross-sectional view illustrating a cross section taken along line VIII-VIII in the display device of FIG. 7.

Referring to FIGS. 7 and 8, tempered glass 500 is used as the lower substrate P of the touch screen panel. The touch screen panel using the tempered glass 500 as the lower substrate P adheres to a liquid crystal panel assembly with an adhesive member 510.

First, the touch screen panel using the tempered glass 500 as the lower substrate P will be described.

A plurality of sensing wires 410 is disposed on the tempered glass 500 in a first direction. One end of the plurality of sensing wires 410 is connected to a touch sensing unit 600. An outer light blocking member 530 is disposed along an edge of the tempered glass 500 and inside the tempered glass 500 in a plan view. An insulating layer 420 is disposed on the entire tempered glass 500 with the plurality of sensing wires 410. The insulating layer 420 may be provided to surround a plurality of sensing wires 410.

A plurality of contact holes H corresponding to the plurality of sensing pads 430 is defined in the insulating layer 420. The plurality of contact holes H is defined at a position corresponding to the position of the plurality of sensing wires 410, and the plurality of sensing wires 410 is exposed by the contact holes H. One contact hole H is defined in each of the plurality of sensing wires 410, and one sensing pad 430 is disposed to correspond to one contact hole H.

The plurality of sensing pads 430 is disposed below the insulating layer 420 and the plurality of contact holes H. Each of the plurality of sensing pads 430 is connected to any one sensing wire 410 through the contact hole H.

Next, the liquid crystal panel assembly will be described.

The liquid crystal panel assembly is configured by a TFT array panel 100, a common electrode panel 200 facing the TFT array panel 100, a liquid crystal layer 3 interposed between the two panels 100 and 200, and a pair of polarizers 11 and 12 attached to outer sides of the two panels 100 and 200.

The adhesive member 510 is provided on the liquid crystal panel assembly, and the plurality of sensing pads 430 of the touch screen panel adheres to the adhesive member 510.

As described above, the plurality of sensing wires 410 of a self cap type touch screen panel is overlapped with the plurality of sensing pads 430, thereby removing a dead zone and improving touch sensitivity of the touch screen panel.

While this invention has been described in connection with what is presently considered to be practical exemplary embodiments, it is to be understood that the invention is not limited to the disclosed exemplary embodiments, but, on the contrary, is intended to cover various modifications and equivalent arrangements included within the spirit and scope of the appended claims.

What is claimed is:

1. A touch screen panel, comprising:
a lower substrate;
a plurality of sensing wires disposed on the lower substrate in a first direction;
an insulating layer disposed on the plurality of sensing wires; and
a plurality of sensing pads disposed on the insulating layer,
wherein a plurality of contact holes is defined in the insulating layer, and the plurality of sensing pads is connected to the plurality of sensing wires through the plurality of contact holes, respectively.

2. The touch screen panel of claim 1, wherein:
a number of the plurality of sensing wires is same as that of the plurality of sensing pads.

3. The touch screen panel of claim 2, further comprising:
a touch sensing unit which is connected to the plurality of sensing wires and senses a change of a capacitance generated in the plurality of sensing pads to detect a touch position.

4. The touch screen panel of claim 2, wherein:
the plurality of sensing pads includes n sensing pads arranged in the first direction, and n sensing wires are disposed below the n sensing pads.

5. The touch screen panel of claim 1, wherein:
the plurality of sensing wires includes an electro-conductive metal material.

6. The touch screen panel of claim 5, wherein:
the plurality of sensing pads includes an electro-conductive transparent material.

7. A display device, comprising:
a thin film transistor array panel;
a common electrode panel which faces the thin film transistor array panel;
a liquid crystal layer interposed between the thin film transistor array panel and the common electrode panel;
a plurality of sensing wires disposed on the common electrode panel in a first direction;
an insulating layer disposed on the plurality of sensing wires; and
a plurality of sensing pads disposed on the insulating layer,
wherein a plurality of contact holes is defined in the insulating layer, and the plurality of sensing pads is connected to the plurality of sensing wires through the plurality of contact holes, respectively.

8. The display device of claim 7, further comprising:
a light blocking member disposed below the common electrode panel to cover a region with a thin film transistor in the thin film transistor array panel,
wherein the plurality of sensing wires is disposed on the light blocking member.

9. The display device of claim 7, wherein:
a number of the plurality of sensing wires is same as that of the plurality of sensing pads.

10. The display device of claim 9, further comprising:
a touch sensing unit which is connected to the plurality of sensing wires and senses a change of a capacitance generated in the plurality of sensing pads to detect a touch position.

11. A display device, comprising:
a thin film transistor array panel;
a common electrode panel which faces the thin film transistor array panel; and
a touch screen panel layer which is disposed between the thin film transistor array panel and the common electrode panel, and includes:
a plurality of sensing wires disposed in a first direction;
an insulating layer disposed below the plurality of sensing wires; and
a plurality of sensing pads disposed below the insulating layer,
wherein a plurality of contact holes is defined in the insulating layer, and the plurality of sensing pads is connected to the plurality of sensing wires through the plurality of contact holes, respectively.

12. The display device of claim 11, further comprising:
a light blocking member disposed below the common electrode panel to cover a region with a thin film transistor in the thin film transistor array panel,
wherein the plurality of sensing wires is disposed below the light blocking member.

13. The display device of claim 12, further comprising:
a plurality of light blocking members below the common electrode panel;
and a color filter disposed in a pixel area between the plurality of light blocking members below the common electrode panel.

14. The display device of claim 12, further comprising:
a plurality of light blocking members below the common electrode panel; and
a color filter disposed in a pixel area which overlaps an opening which is defined between the plurality of light blocking members on the thin film transistor array panel.

15. The display device of claim 11, further comprising:
a light blocking member disposed on the thin film transistor array panel to cover a region with a thin film transistor in the thin film transistor array panel,
wherein the plurality of sensing wires is disposed below the common electrode panel on a portion where the light blocking member is positioned.

16. The display device of claim 15, further comprising:
a plurality of light blocking members disposed below the common electrode panel; and
a color filter disposed in a pixel area which overlaps an opening which is defined between the plurality of light blocking members on the thin film transistor array panel.

17. The display device of claim 11, further comprising:
a first polarizer disposed below the thin film transistor array panel; and
a second polarizer disposed on the common electrode panel.

18. A display device, comprising:
a liquid crystal panel assembly including a thin film transistor array panel, a common electrode panel which faces the thin film transistor array panel, and a liquid crystal layer interposed between the thin film transistor array panel and the common electrode panel; and
a touch screen panel including tempered glass, a plurality of sensing wires disposed on the tempered glass in a first direction, an insulating layer disposed on the plurality of sensing wires, and a plurality of sensing pads disposed on the insulating layer to be connected to the plurality of sensing wires through a plurality of contact holes defined in the insulation layer,
wherein an adhesive member is provided on the liquid crystal panel assembly, and the plurality of sensing pads of the touch screen panel adheres to the adhesive member.

19. The display device of claim 18, wherein:
a number of the plurality of sensing wires is same as that of the plurality of sensing pads.

20. The display device of claim 19, further comprising:
a touch sensing unit which is connected to the plurality of sensing wires and senses a change of a capacitance generated in the plurality of sensing pads to detect a touch position.
